(19) United States
(12) Patent Application Publication
(10) Pub. No.: US 2019/0138373 A1
(43) Pub. Date: May 9, 2019

(54) MULTITHREADED DATA FLOW PROCESSING WITHIN A RECONFIGURABLE FABRIC

(71) Applicant: Wave Computing, Inc., Campbell, CA (US)

(72) Inventors: Christopher John Nicol, Campbell, CA (US); Derek William Meyer, Truckee, CA (US)

(21) Appl. No.: 16/234,728

(22) Filed: Dec. 28, 2018

Related U.S. Application Data
(63) Continuation-in-part of application No. 16/170,268, filed on Oct. 25, 2018.
(60) Provisional application No. 62/773,486, filed on Nov. 30, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.

(51) Int. Cl. G06F 9/54; G06F 9/48; G06F 9/52; G06F 9/445; G06F 9/30; G06F 9/38; G06N 20/00

(52) U.S. Cl. CPC G06F 9/545; G06F 9/4881; G06F 9/52; G06N 20/00; G06F 9/3005; G06F 9/38; G06F 9/44505

(57) ABSTRACT

Techniques are disclosed for multithreaded data flow processing within a reconfigurable fabric. Code is obtained for performing data manipulation within a reconfigurable fabric. The code is segmented into a plurality of data manipulation operations. A first segment from the segmenting is allocated to a first set of processing elements within a plurality of processing elements comprising a reconfigurable fabric. A second segment from the segmenting is allocated to a second set of processing elements within the reconfigurable fabric. The first segment is executed on the first set of processing elements while the second segment is executed on the second set of processing elements. The first kernel and the second kernel comprise multithreaded operation.

### RELATED APPLICATIONS

This application claims the benefit of U.S. provisional patent applications “Multithreaded Dataflow Processing Within a Reconfigurable Fabric” Ser. No. 62/611,600, filed Dec. 29, 2017, “Dynamic Reconfiguration With Partially Resident Agents” Ser. No. 62/611,588, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, and “Reconfigurable Fabric Configuration Using Spatial and Temporal Routing” Ser. No. 62/773,486, filed Nov. 30, 2018.

This application is also a continuation-in-part of U.S. patent application “Tensor Manipulation Within a Neural Network” Ser. No. 16/170,268, filed Oct. 25, 2018, which claims the benefit of U.S. provisional patent applications “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637,614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data manipulation and more particularly to multithreaded data flow processing within a reconfigurable fabric.

### BACKGROUND

The increasing quantity of data collected by entities such as businesses, governments, and researchers, for a variety of purposes, can easily overwhelm the capabilities of traditional designs and architectures of processors, integrated circuits, and other computing hardware. The entities collect the data to meet objectives such as learning, prediction, surveillance, and tracking. The collected datasets, often called “big data”, present tremendous data processing challenges due to the sheer volume of the data that has been collected. While the data handling and processing challenges are significant, the various agencies that collect the data are highly motivated to process the data and to analyze the results. The data is processed for different commercial, research, and security purposes such as learning, marketing, and predicting, among many other tasks. Further to the processing, the analysis, capture, maintenance, storage, transmission, visualization, and so on, of the data, saturate the processing and handling capabilities of the traditional systems. Instead, new processing hardware such as advanced computer chips and architectures, and software such as algorithms, heuristics, functions, and so on, are required to extract meaningful data from the big datasets. The success of the new approaches can be measured using computational metrics and other metrics. The metrics can include high throughput such as high data throughput, fast data processing response time, low computational resources utilization, and so on.

Neural networks, commonly called artificial neural networks (ANN), mimic biological neural networks. These computational systems “learn” based on developing improved system performance while executing a given task. The task can include image recognition, speech recognition, and other computationally intensive applications. This “learning”, called machine learning, is based on the premise that computers can be trained to perform a task without being specifically programmed to do so. The training builds algorithms to learn using a known dataset (supervised learning). The algorithms can then be used to make predictions about the current and future datasets. The advantage of machine learning is that the algorithms are based on models. The algorithms can adapt and improve over time based on past experience with data such as prediction success rates and error rates. A model is constructed from a set of sample data with known characteristics. The model is trained using the known data to make desired predictions and decisions. Once the model has been trained, the model is applied to other datasets. The model can be updated over time based on the success rate of the model to make correct predictions using the data. Applications of such machine learned models include: network and system intrusion detection; optical character recognition (OCR); email filtering for spam detection, computer vision (CV); and so on. The success of the model is limited by the quality of the training data. Analysis of the training data often requires human intervention, so such analysis is both expensive and at risk of human error.

Deep neural networks (DNN) are a form of artificial neural networks (ANN). Like artificial neural networks, the deep neural networks are based on layers. For the deep neural networks, there can be multiple hidden layers between the input layer and the output layer. DNNs are well suited to modeling complex, non-linear relationships. A DNN can be used to generate a compositional model. A compositional model can support automatic formulation of models using explicit representation for modeling assumptions. The compositional model can be expressed as a layered composition of primitive data types. The additional layers of the DNN can support formulation of features from lower layers of the composition. The result can be modeling the complexities of data using fewer computational resources.

### SUMMARY

Reconfigurable computing includes architectures that incorporate a combination of circuit techniques and coding techniques. The hardware within the reconfigurable architectures is efficiently designed and achieves high performance when compared to the performance of general purpose hardware. Further, these reconfigurable architectures can be adapted or “recoded” based on techniques similar to those used to modify software. That is, the reconfigurable architecture can be adapted by changing the code used to configure the elements of the architecture. A reconfigurable fabric is one such architecture that can be successfully used for reconfigurable computing. Reconfigurable fabrics can be coded to represent a variety of processing topologies. The topologies are coded to perform the many applications that require high performance computing. Applications such as processing of unstructured data, digital signal processing (DSP), machine learning, neural networks such as convolutional neural networks (CNN) and deep neural networks (DNN), and so on, are well served by the capabilities of a reconfigurable fabric. The capabilities of the reconfigurable fabric perform particularly well when the data includes specific types of data, large quantities of unstructured data, and so on. The reconfigurable fabric is configured by coding or scheduling the reconfigurable fabric to execute these and other processing techniques. The reconfigurable fabric can be scheduled to configure a variety of computer architectures that can perform various types of computations with high efficiency. The scheduling of the reconfigurable fabric can be changed based on a data flow graph.

Neural networks can be used to process vast quantities of unstructured data. The neural networks can manipulate tensors, where the tensors can represent the data including the unstructured data. Neural networks are finding many data processing applications in diverse fields such as machine learning, including deep learning, artificial intelligence, business and research applications such as trend analysis, and so on. Von Neumann and other traditional control flow computational architectures are not well suited to highly data-intensive processing requirements. Although designers and architects continue to construct faster processors, improved custom integrated circuits or chips, more capable application specific integrated circuits (ASIC), and so on, the new designs and architectures still fail to meet the data processing demands because these architectures are not designed specifically for processing vast amounts of data. An alternative architecture to the control flow architectures is based on data flow. In a data flow architecture, the execution of instructions, functions, subroutines, etc., is based on the presence or absence of data. This latter approach, that of a data flow architecture, is better suited to handling the large amounts of unstructured data that are processed as part of the machine learning and deep learning applications.

Data manipulation is performed based on multithreaded data flow processing within a reconfigurable fabric. The reconfigurable fabric includes a variety of “elements” such as processing elements, switching elements, storage elements, communications capabilities, and so on. Embodiments include a processor-implemented method for data manipulation comprising: obtaining code for performing data manipulation on a reconfigurable fabric; segmenting the code into a plurality of data manipulation operations; allocating a first segment from the segmenting to a first set of processing elements within a plurality of processing elements which comprise a reconfigurable fabric; allocating a second segment from the segmenting to a second set of processing elements within the reconfigurable fabric; and executing the first segment on the first set of processing elements while executing the second segment on the second set of processing elements.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for multithreaded data flow processing within a reconfigurable fabric.

FIG. 2 is a flow diagram for multithreaded operation.

FIG. 3 shows control and logic for multiple thread processing.

FIG. 4 illustrates breaking code into multiple threads.

FIG. 5 shows allocating multiple threads to workgroups.

FIG. 6 shows dynamically allocating a thread to a workgroup.

FIG. 7 is an example showing a server allocating a data flow graph.

FIG. 8 shows a cluster for coarse-grained reconfigurable processing.

FIG. 9 shows a block diagram of a circular buffer.

FIG. 10 illustrates a circular buffer and processing elements.

FIG. 11 shows a deep learning block diagram.

FIG. 12 is a system diagram for multithreaded data flow processing within a reconfigurable fabric.

### DETAILED DESCRIPTION

Techniques are disclosed for multithreaded data flow processing within a reconfigurable fabric. Data flow processing models a computation process based on a data flow graph. The data flow graph includes nodes and arcs, where the nodes include processing tasks and the arcs describe the flow of data between and among nodes. The processing tasks undertaken by the nodes can be based on kernels. The kernels are code segments derived from segmented or partitioned code that is encoded for performing one or more data manipulations. The data manipulations can include mathematical operations, Boolean operations, tensor operations, etc. The kernels comprise multithreaded operations. A thread represents a sequence of coded instructions that can be managed or scheduled independently. Multiple threads can be executed simultaneously as part of a process that performs data manipulation. The multiple threads which make up the multithreaded data flow processing share processing resources. The processing resources include storage, kernel variables, kernel states, and so on. The multithreaded operation uses synchronization between and among kernels to ensure that the performing the data manipulation is executed properly. The synchronization between and among the kernels uses semaphores. A semaphore, which can include a variable, an abstract data type, and so on, is used to control access of two or more kernels to common resources.

A reconfigurable fabric can include one or more types of elements. The element can be configured to perform a variety of architectural and computational tasks, based on the type of element. The elements can be configured as processing elements, storage elements, switching elements, and so on. The reconfigurable fabric can include quads or workgroups of elements, where the workgroups can include processing elements, shared storage elements, switching elements, circular buffers for control, communications paths, and the like. An element within the reconfigurable fabric can be controlled by providing code, where the code configures the element as a processing element, switching element, storage element, etc. Code can also be provided to a plurality of elements within the reconfigurable fabric so that the reconfigurable fabric can perform various computational tasks such as performing computations using kernels. The various elements of the reconfigurable fabric can be controlled using one or more rotating circular buffers. Functions, algorithms, instructions, codes, etc., can be loaded into a given circular buffer. The one or more circular buffers can be of the same length or of differing lengths. The rotation of the circular buffer ensures that the same series of steps or instructions is repeated as required by the processing tasks assigned to a processing element of the reconfigurable fabric. The one or more rotating circular buffers can be statically scheduled.

Multithreaded data flow processing is executed within a reconfigurable fabric. Code for performing data manipulation on a reconfigurable fabric is obtained, and the code is segmented into a plurality of data manipulation operations. The segmented operations can include mathematical operations, Boolean operations, tensor operations, and so on. A segment can comprise a kernel where a kernel can be part of a computational process. A plurality of kernels can be part of data flow processing, where data flow processing is represented by a data flow graph. The reconfigurable fabric includes a variety of elements such as processing elements, communications capabilities, storage elements, switching elements, and so on. A first segment from the segmenting is allocated to a first set of processing elements within a plurality of processing elements which comprise the reconfigurable fabric. A second segment from the segmenting is allocated to a second set of processing elements within the reconfigurable fabric. The first set of processing elements and the second set of processing elements can include quads, workgroups, etc., of processing elements. The first segment is executed on the first set of processing elements while the second segment is executed on the second set of processing elements. The first kernel and the second kernel include a multithreaded operation. The multiple threads of the multithreaded operation can include processing acceleration, processing parallelization, and sharing processing resources.

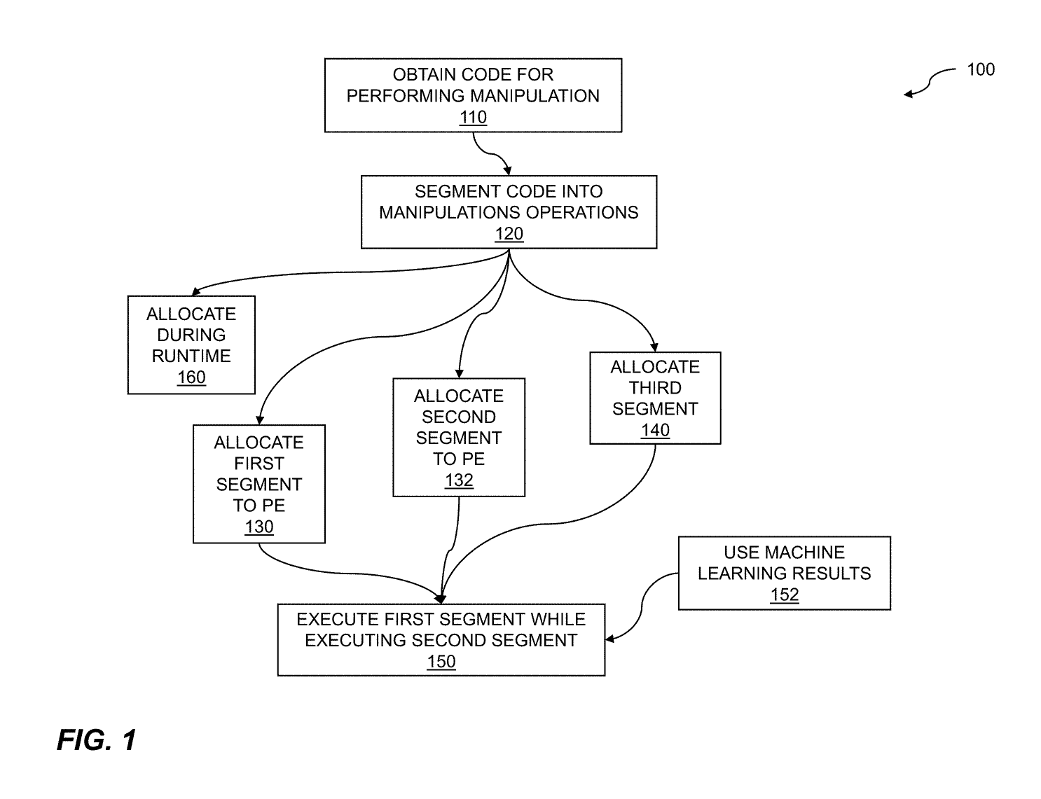

FIG. 1 is a flow diagram for multithreaded data flow processing within a reconfigurable fabric. The flow 100 includes obtaining code for performing data manipulation 110 on a reconfigurable fabric. The code can include instructions, functions, subroutines, and so on, for performing data manipulations such as mathematical operations, Boolean operations, tensor operations, etc. The flow 100 includes segmenting the code into a plurality of data manipulation operations 120. The segmenting can be based on multiple threads, where the threads can include sequences of coded instructions from the code for performing the data manipulation. The threads can be managed independently by a controller, a manager, a scheduler, etc. The flow 100 includes allocating a first segment from the segmenting to a first set of processing elements 130 within a plurality of processing elements which comprise a reconfigurable fabric. A reconfigurable fabric can include elements comprising processing elements, switching elements, storage elements, and so on. The reconfigurable fabric can be controlled by one or more rotating circular buffers. The reconfigurable fabric can include asynchronous logic. The asynchronous logic can include self-timed logic, data flow logic, etc. In embodiments, the reconfigurable fabric can include hum circuitry for self-clocking. The first set of processing elements can include a quad, a workgroup, etc. The flow 100 includes allocating a second segment from the segmenting to a second set of processing elements 132 within the reconfigurable fabric. As for the first set of processing elements, the second set of processing elements can include a quad, a workgroup, or other set that includes one or more processing elements. In embodiments, the processing elements, switching elements, or storage elements can be controlled by rotating circular buffers. The rotating circular buffers can include code which can be executed while the circular buffer rotates. Rotation of the circular buffers can be started, stopped, suspended, or resumed based on the availability of data, control signals, etc. In embodiments, rotating circular buffers are statically scheduled. The static schedules of the rotating circular buffers can be set to control the processing elements, access the data, etc. In embodiments, the first set of processing elements and the second set of processing elements comprise heterogeneous computing.

In embodiments, the first segment comprises a first kernel and the second segment comprises a second kernel. A kernel can include an assembled, compiled, translated, etc., sequence of coded instructions that can be efficiently executed on one or more processing elements. The kernel can be configured to operate on a quad of processing elements, on a workgroup of processing elements, and the like. In embodiments, the first kernel and the second kernel can be part of data flow processing. Data flow processing can be based on the availability of data to be processed rather than on the control of the flow of data through a processor. That is, when data is available and valid at the one or more inputs to a process, then the process can be performed or can “fire”. A performed process can represent a transition. Otherwise, the process is not performed. In embodiments, the data flow processing can be represented by a data flow graph. A data flow graph can represent system processing portions of the flow of data through a plurality of processors. The data flow graph can include nodes which can represent processors and arcs which can represent data flow between and among processors. In embodiments, the first kernel and the second kernel comprise multithreaded operation.

The flow 100 includes executing the first segment on the first set of processing elements while executing the second segment on the second set of processing elements 150. The executing the first segment and the executing the second segment can include processing data such as tensor data, unstructured data, and so on. The first set of processing elements can access a first memory while executing the first segment. Similarly, the second set of processing elements can access a second memory while executing the second segment. The data can be obtained from a storage element within the reconfigurable fabric. The memory can include memory external to the reconfigurable fabric, and so on. In embodiments, the memory external to the reconfigurable array can include direct memory access (DMA) storage. The first memory and the second memory can be unique from one another. The data can be obtained from hyper memory cube (HMC) storage. In embodiments, the first memory and the second memory can be within one or more hybrid memory cubes. The first segment and the second segment can share processing resources, storage resources, and so on. The sharing processing resources can include sharing kernel values, kernel states, etc. In embodiments, accesses of memory by the first segment and accesses of memory by the second segment can occur without contention. The memory access can include accessing a dual-port memory, accessing separate memories such as storage elements, etc.

The executing the first segment and the executing the second segment can be part of machine learning. The machine learning can form algorithms, heuristics, and so on to make predictions about the data being processed by the first segment and by the second segment. In embodiments, the executing the first segment and the executing the second segment can use results of machine learning 152. The machine learning can be based on learning layers and weights within a neural network. The neural network can include a deep convolutional neural network (DCNN). The DCNN can include input layers, output layers, convolutional layers, rectifier linear units (ReLU), bottleneck layers, etc. The machine learning can add or reduce layers of the DCNN, can adjust the connections between layers, can adjust the weights of nodes within layers of the DCNN, and so on.

The flow 100 can include dynamically allocating a third segment 140 from the segmenting to the second set of processing elements within the reconfigurable fabric. The dynamic allocation can occur subsequent to the start of the executing the first segment on the first set of processing elements while executing the second segment on the second set of processing elements 150, in which case the third segment can dynamically replace the second segment on the second set of processing elements to perform a third kernel. The third kernel can include additional functions related to the first kernel and the second kernel. Some embodiments include dynamically allocating a third segment from a segmenting of code for performing a further data manipulation to the second set of processing elements within the reconfigurable fabric. In embodiments, the allocating occurs during runtime 160. In some embodiments, the second segment can be dynamically reallocated to the second set of processing elements after the third segment has completed a function or task.

The multithreaded operation of executing the first segment and executing the second segment comprises synchronization between the first kernel and the second kernel. The synchronization can be used to indicate that data is ready for processing, that data has been processed, and so on. The synchronization can be based on signals such as fire, input buffer empty, output buffer empty, start, done, suspend, and so on. In embodiments, the synchronization between the first kernel and the second kernel uses semaphores. A semaphore can include a variable, a datatype such as an abstract datatype, and so on, which can be used control access to common resources. The common resources, such as processing elements, storage elements, HMC, DMA storage, etc., can be accessed by multiple threads based on values, states, etc., of one or more semaphores. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

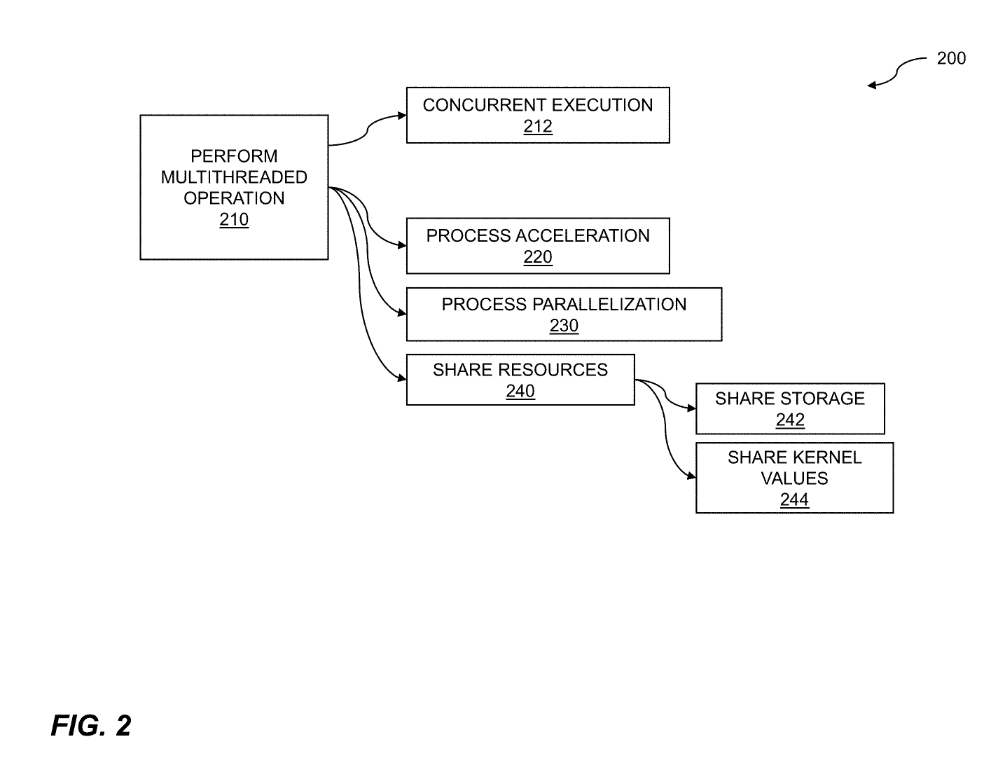

FIG. 2 is a flow for multithreaded operation. Multithreaded operation is a coding technique which can support multiple threads within the context of a given process. The threads can share the computational resources of the process and can operate independently of the other process threads. The multiple threads can be executed concurrently. In embodiments, the first kernel and the second kernel comprise multithreaded operation, wherein the multithreaded operation comprises concurrently executed threads. Multithreaded operation supports multithreaded data flow processing within a reconfigurable fabric. The flow 200 includes performing multithreaded operation 210. The multithreaded operation can be based on kernels, where the kernels can include segments of code. The segments of code can result from segmenting a code for performing data manipulation on a reconfigurable fabric. The data manipulation can include a mathematical operation, a Boolean operation, a tensor operation, etc. In the flow 200, the multithreaded operation can include concurrent execution 212, in which more than one segment, thread, or kernel, can run simultaneously on a reconfigurable fabric. The multithreaded operation can be run synchronously on two or more processors, asynchronously on two or more processors, or a combination of both synchronously and asynchronously. In the flow 200, the multithreaded operation can include processing acceleration 220. The processing acceleration can be based on reducing movement of the data being processed. In a traditional processor architecture, data can be processed by passing the data through one or more modules. The data can be fetched from storage, processed by the first module and stored in intermediate storage or external storage, processed by a second module and stored in intermediate storage or external storage, and so on, until the processed data is finally returned to storage such as the external storage. By storing the data locally to the processors, and by sharing the data between and among processors, the data can remain “local” during processing. Locality of data can refer to data stored in storage such as a hybrid memory cube, where the hybrid memory cube can communicate with a set of processing elements. In the flow 200, the multithreaded operation can include processing parallelization 230. The various threads of the multithreaded operation can be assigned to workgroups in the reconfigurable fabric. A workgroup can include a set of processing elements within the reconfigurable fabric. A given process thread can be executed while the other threads of the process are also being executed.

The flow 200 includes sharing processing resources 240. The processing resources can include processing resources of the reconfigurable fabric. The processing resources can include workgroups, storage, etc. The workgroups can include one or more sets of processing elements within the reconfigurable fabric. The shared processing resources can include sharing storage 242. The storage can include storage elements within the reconfigurable fabric, storage including memory external to the reconfigurable fabric, and so on. The memory external to the reconfigurable array can include direct memory access (DMA) storage. The storage can include hybrid memory cubes. The sharing processing resources can include sharing kernel values 244. The kernel values can include data, intermediate data, states, flags, semaphores, and so on.

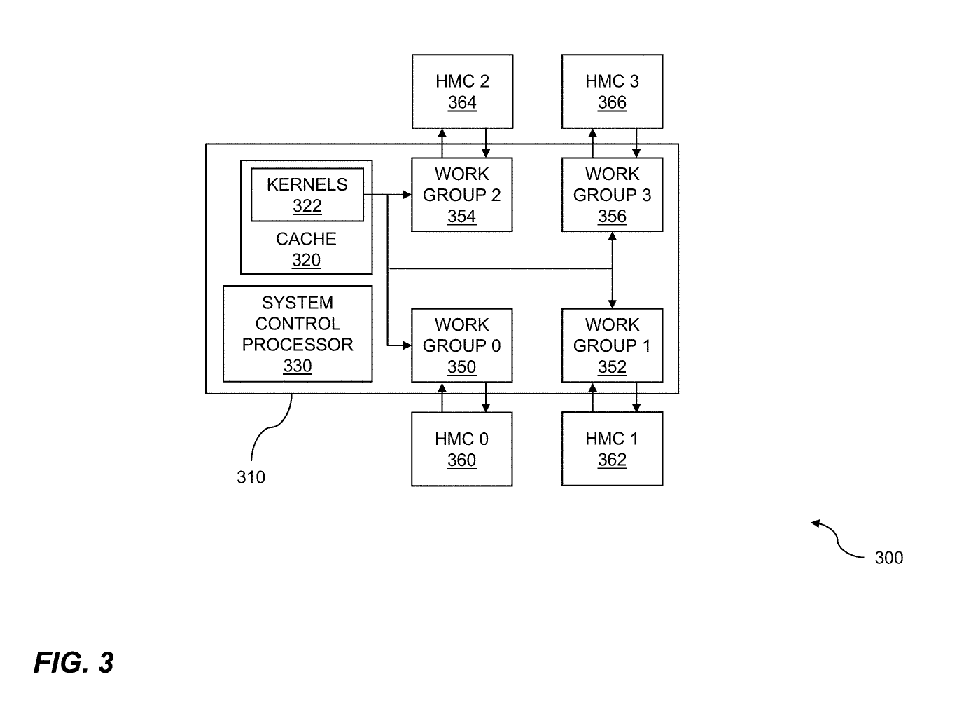

FIG. 3 shows control and logic for multiple thread processing. Multiple thread or multithread processing can be based on data flow processing, where data flow processing can be represented by a data flow graph. The data flow graph can include nodes and arcs, where the nodes can be based on code segments, kernels, agents, etc. The code segments result from segmenting a process such as the data flow process. The process can comprise multiple threads, where the multiple threads can include one or more kernels. The kernels can be allocated to sets of processing elements within a reconfigurable fabric. The sets of processing elements can be arranged into quads, workgroups, and so on, and can be used for executing the multiple threads. Multithreaded data flow processing occurs within a reconfigurable fabric.

A reconfigurable fabric 300 is shown, within which kernels from multithreaded data flow processing can be controlled and executed. The reconfigurable fabric can include elements such as processing elements, switching elements, storage elements, and the like. Processing to be performed on the reconfigurable fabric 310 can be described by a data flow graph. The data flow graph to be processed on the reconfigurable fabric can require more elements than are available on the reconfigurable fabric. Kernels can be time multiplexed in being loaded into the reconfigurable fabric. Dynamic reconfiguration can be used for scheduling and loading the kernels. Kernels 322, such as kernels included in code segments, can be stored in a cache 320. The cache can include storage elements within the reconfigurable fabric, storage coupled to the reconfigurable fabric, and so on. The loading, executing, voiding, etc., of the kernels can be manipulated by a system control processor 330. The system control processor can include rotating circular buffers. In embodiments, the rotating circular buffers can be statically scheduled. The system control processor can allocate kernels stored in the cache to workgroups within the reconfigurable fabric. The workgroups can include workgroup 0 350, workgroup 1 352, workgroup 2 354, workgroup 3 356, and so on. Other numbers of workgroups can be included within a reconfigurable fabric. A workgroup can be in communication with a hybrid memory cube (HMC). Workgroup 0 can be in communication with HMC 0 360, workgroup 1 can be in communication with HMC 1 362, workgroup 2 can be in communication with HMC 2 364, and workgroup 3 can be in communication with HMC 3 366. The one or more HMCs can be coupled to the reconfigurable fabric. In embodiments, the memories external to the reconfigurable array can include direct memory access (DMA) storage.

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents which are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals but will not commence the processing of any new tensor data until the current tensor processing by the agent has been completed. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to be fully vacant because a fire signal might be sent to the agent by the upstream agent. When the upstream agent is partially resident or is fully vacant, then the agent can be fully vacated from the reconfigurable fabric. The agent can be fully vacated if it asserts both the signals input buffers empty and output buffers empty.

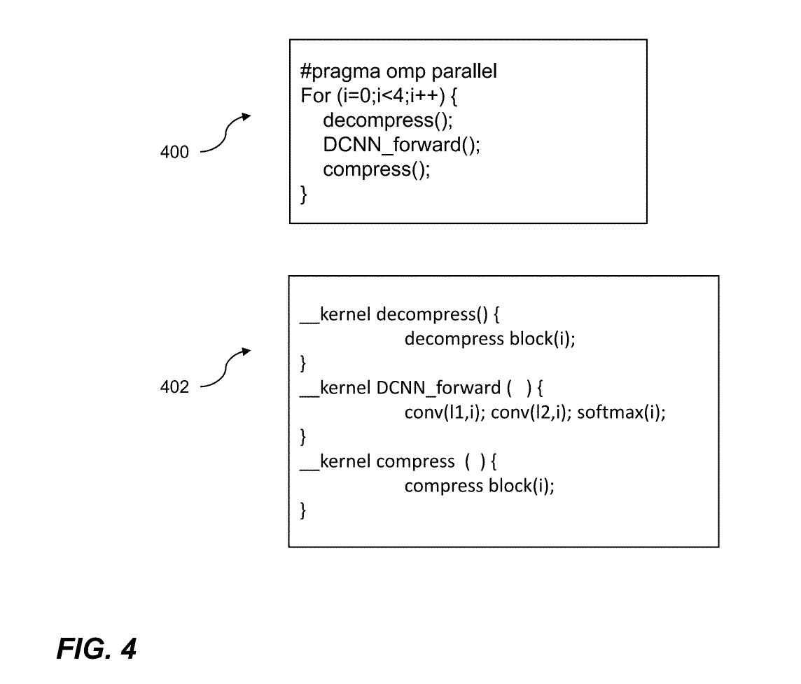

FIG. 4 illustrates breaking code into multiple threads. Code can be obtained for performing data manipulation on a reconfigurable fabric. The data manipulation can include mathematical operations, Boolean operations, tensor operations, etc. The code can be partitioned or segmented into segments, where the segments include the data manipulation operations. A segment can comprise a kernel, an agent kernel, and so on. A kernel can include a kernel control unit. The one or more kernels can be part of data flow processing, where the data flow processing can be represented by a data flow graph. Kernels, such as a first kernel and a second kernel, can include multithreaded operation. The one or more threads of the multithreaded operation can be parts of a process, where the threads of the process can be executed on a reconfigurable fabric. The reconfigurable fabric can include elements, such as processing elements, switching elements, storage elements, and so on. The elements such as processing elements can be grouped into sets, quads, workgroups, and so on. The threads from the multithreaded data flow processing can be executed within the reconfigurable fabric. The multiple threads of a process can be allocated to the workgroups in order to accelerate execution of the process. The acceleration can result from reducing the numbers of transfers of data required during execution of the process.

A technique for breaking code into multiple threads is shown. The code 400 shows an arrangement of steps that can be taken by one or more threads. In 400, four threads, thread 0, thread 1, thread 2, and thread 3, are generated. Each thread can perform a series of operations, where the series of operations can be common among the threads. The operations can include decompression, deep convolutional neural network forwarding, compression, and so on. The threads can include more or fewer steps, including other operations such as mathematical operations, Boolean operations, tensor operations, etc. The threads can be scheduled, executed, etc., independently of one other. In embodiments, the multithreaded operation can include sharing processing resources. The sharing can include sharing switching elements, storage elements, and so on. In embodiments, the sharing processing resources can include sharing storage. The storage can include storage elements within the reconfigurable fabric, storage resources coupled to the reconfigurable fabric, and the like. In embodiments, the sharing processing resources can include sharing values of kernel variables and kernel states. The kernel variables can include integers, reals, floats, characters, and so on. The kernel states can include initial states, terminal states, etc. In embodiments, the multithreaded operation can include synchronization between a first kernel and a second kernel. The synchronization can include flags, register bits, and the like. In embodiments, the synchronization between the first kernel and the second kernel uses semaphores.

Each operation of the threads can include one or more kernels 402. A kernel can include compiled routines, which when executed on a workgroup of a reconfigurable fabric, perform one or more of the operations described above. In 402 the kernels can include decompress, deep convolutional neural network (DCNN) forward, compress, and so on. Decompress can perform an operation on a block such as a block of data, a tensor block, etc. DCNN forward can perform operations such as one or more convolutions, a softmax function, etc. A softmax function can compress a k-dimensional vector of arbitrary values into a k-dimensional vector of values that range [0, 1] and add up to one. Compress can perform a compression operation on a block. The variables accessed by the kernels can be shared among the kernels of a given thread, shared among threads, etc. While the kernels of a given thread can be executed in a specified order, the kernels of a process can be executed together.

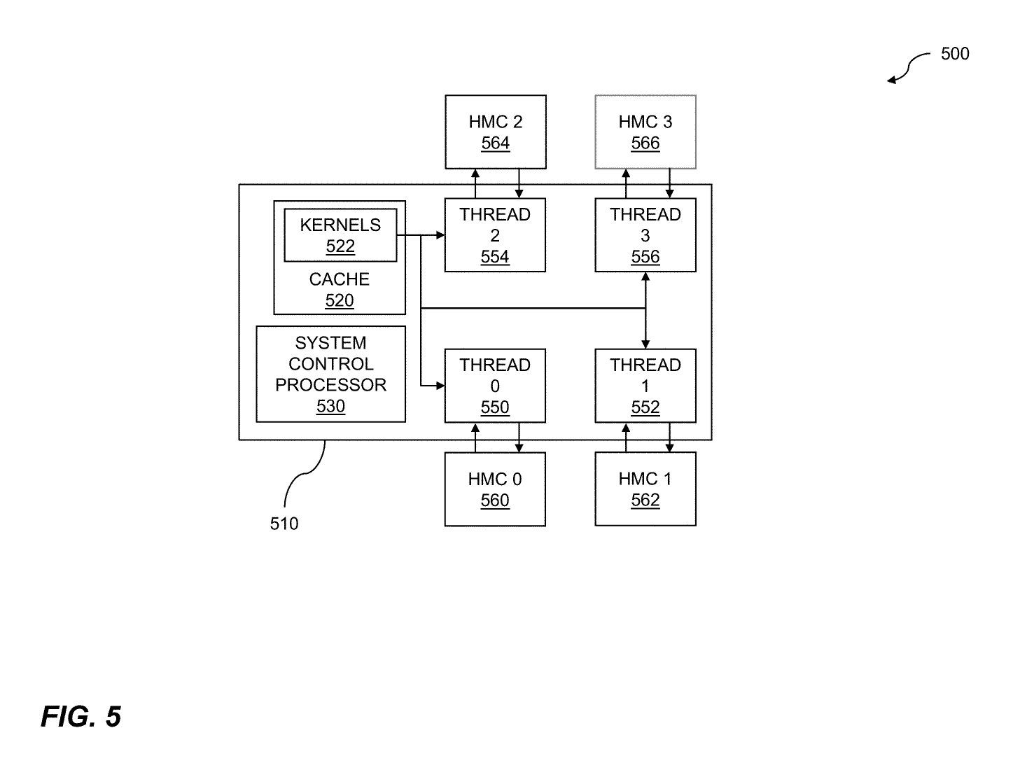

FIG. 5 shows allocating multiple threads to workgroups 500. A thread can include a small segment of programmed or coded instructions that can be assigned to workgroups of processing elements for execution. In embodiments, the thread comprises a kernel running on the reconfigurable fabric. The processing elements can be included among other elements, such as switching elements and storage elements, within a reconfigurable fabric. When multiple threads result from segmenting code, the threads can be managed independently from one another by a controller or scheduler. The one or more threads can be parts of a process. Execution of the threads can support multithreaded data flow processing within a reconfigurable fabric. The multiple threads can be allocated to the workgroups of processing elements to accelerate execution of the process. The acceleration can result from reducing the numbers of transfers of data required during execution of the process.

A reconfigurable fabric 510 can include a cache 520. The cache can include storage elements within a reconfigurable fabric, storage elements external to the reconfigurable fabric, and so on. The storage external to the reconfigurable array can include direct memory access (DMA) storage. The cache can be loaded with one or more kernels 522. One or more kernels can be included in a segment, where the segment can include a code segment. The code segment can result from segmenting a code for performing data manipulation on a reconfigurable fabric. The data manipulation can include a mathematical operation, a data operation, a tensor operation, and so on. The reconfigurable fabric can include a system control processor 530. The system control processor can access the cache, allocate threads to workgroups, control data flow, and the like. The system control processor can include one or more rotating circular buffers. In embodiments, the rotating circular buffers can be statically scheduled.

In the FIG. 500, four threads are shown, thread 0 550, thread 1 552, thread 2 554, and thread 3 556. While four threads are shown, other numbers of threads can be included in processing of a multithreaded data flow process. The threads of the multithreaded process can be allocated to workgroups. Thread 0 can be allocated to a workgroup 550, thread 1 can be allocated to a workgroup 552, thread 2 can be allocated to workgroup 554, and thread 3 can be allocated to workgroup 556. Each workgroup can be coupled to a hybrid memory cube (HBC), storage external to the reconfigurable fabric, etc. A hybrid memory cube can include multiple dies of memory cells, sandwiched together, and interconnected using through silicon vias (TSV). A given workgroup can access data, instructions, and so on within the HBC. In 500, thread 0 can access HMC 0 560, thread 1 can access HMC 1 562, thread 2 can access HMC 2 564, and thread 3 can access HMC 3 566.

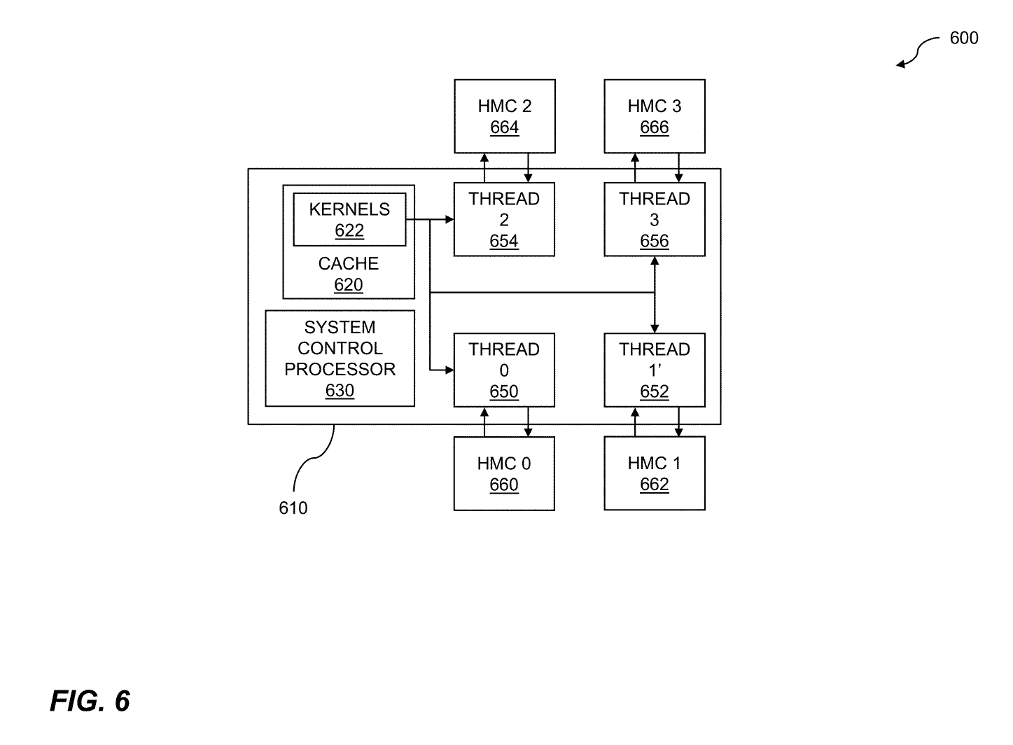

FIG. 6 shows dynamically allocating a thread to a workgroup 600. A thread can include a small segment of programmed or coded instructions that can be assigned to workgroups of processing elements for execution. In embodiments, the thread comprises a kernel running on the reconfigurable fabric. The processing elements can be included among other elements, such as switching elements and storage elements, within a reconfigurable fabric. When multiple threads result from segmenting code, the threads can be managed independently of one another by a controller or scheduler. The one or more threads can be parts of a process. Execution of the threads can support multithreaded data flow processing within a reconfigurable fabric. The multiple threads can be allocated to the workgroups of processing elements to accelerate execution of the process. The acceleration can result from reducing the numbers of transfers of data required during execution of the process.

A reconfigurable fabric 610 can include a cache 620. The cache can include storage elements within a reconfigurable fabric, storage elements external to the reconfigurable fabric, and so on. The storage external to the reconfigurable array can include direct memory access (DMA) storage. The cache can be loaded with one or more kernels 622. One or more kernels can be included in a segment, where the segment can include a code segment. The code segment can result from segmenting a code for performing data manipulation on a reconfigurable fabric. The data manipulation can include a mathematical operation, a data operation, a tensor operation, and so on. The reconfigurable fabric can include a system control processor 630. The system control processor can access the cache, allocate threads to workgroups, control data flow, and the like. The system control processor can include one or more rotating circular buffers. In embodiments, the rotating circular buffers can be statically scheduled.

In the FIG. 600, four threads are shown, thread 0, thread 1, thread 2, and thread 3. While four threads are shown, other numbers of threads can be included in processing of a multithreaded data flow process. The threads of the multithreaded process can be allocated to workgroups. Thread 0 can be allocated to a workgroup 650, thread 1 could have been originally allocated to a workgroup 652, but it can be dynamically replaced by thread 1′ (“thread one prime”), which can be a third segment from the segmented code. Also, thread 2 can be allocated to workgroup 654 and thread 3 can be allocated to workgroup 656. Each workgroup can be coupled to a hybrid memory cube (HBC), storage external to the reconfigurable fabric, etc. A hybrid memory cube can include multiple dies of memory cells, sandwiched together, and interconnected using through silicon vias (TSV). A given workgroup can access data, instructions, and so on within the HBC. In 600, thread 0 can access HMC 0 660, thread 1′ can access HMC 1 662, thread 2 can access HMC 2 664, and thread 3 can access HMC 3 666. Thread 1′ 652 can dynamically replace a previously loaded thread, or kernel, to perform a new function in the middle of the operation of the reconfigurable fabric. Thus, the multithreaded process can include dynamically replaced segments running on the same processing element or cluster at a different point in time.

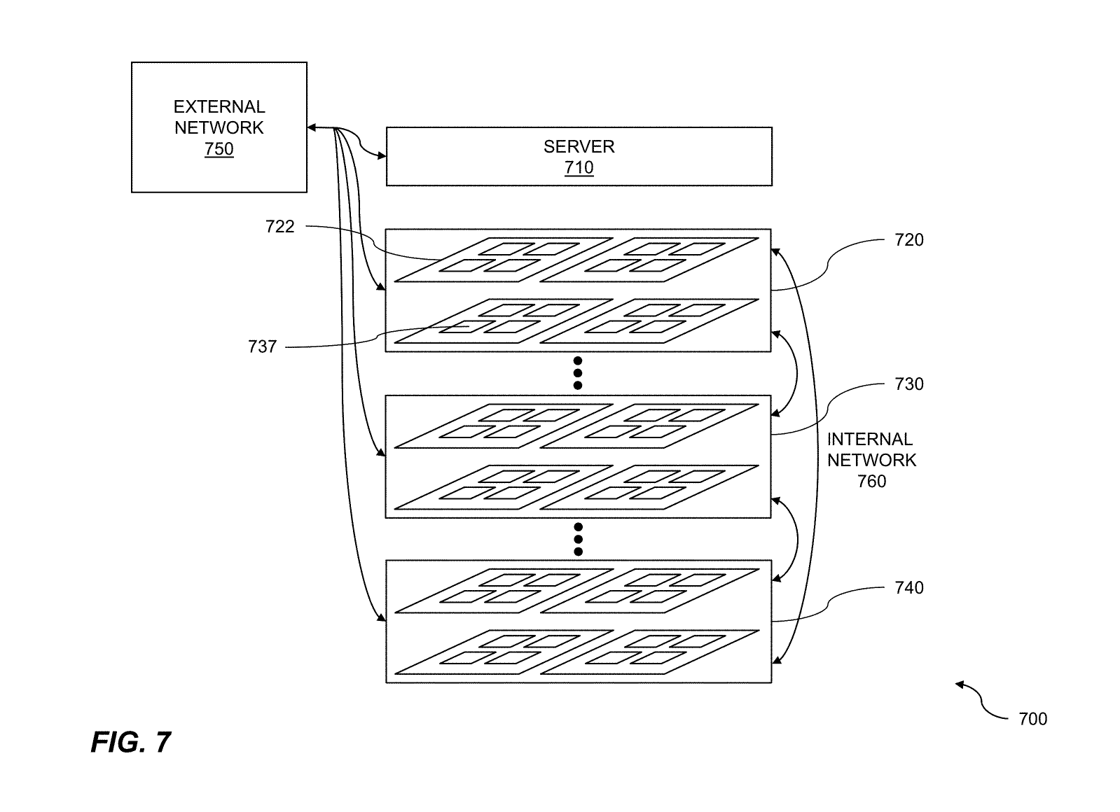

FIG. 7 is an example showing a server allocating a data flow graph. A data flow graph can represent data flow processing. The data flow processing can include kernels, where the kernels can include multithreaded operation. Multithreaded data flow processing can be performed within a reconfigurable fabric. A system 700 can allocate one or more first-in first-outs (FIFOs) and processing elements (PEs) for reconfigurable fabric data routing. The system 700 can include a server 710 allocating FIFOs and processing elements. In embodiments, system 700 includes one or more boxes, indicated by callouts 720, 730, and 740. Each box may have one or more boards, indicated generally as 722. Each board comprises one or more chips, indicated generally as 737. Each chip may include one or more processing elements, where at least some of the processing elements may execute a process agent. An internal network 760 allows communication between the boxes such that processing elements on one box can provide and/or receive results from processing elements on another box.

The server 710 may be a computer executing programs on one or more processors based on instructions contained in a non-transitory computer readable medium. The server 710 may perform reconfiguring of a mesh networked computer system comprising a plurality of processing elements with a FIFO between one or more pairs of processing elements. In some embodiments, each pair of processing elements has a dedicated FIFO configured to pass data between the processing elements of the pair. The server 710 may receive instructions and/or input data from external network 750. The external network may provide information that includes, but is not limited to, hardware description language instructions (e.g. Verilog, VHDL, or the like), flow graphs, source code, or information in another suitable format.

The server 710 may collect performance statistics on the operation of the collection of processing elements. The performance statistics can include the number of fork operations, the number of join operations, average sleep time of a processing element, and/or a histogram of the sleep time of each processing element. Any outlier processing elements that sleep longer than a predetermined threshold time period can be identified. In embodiments, the server can resize FIFOs or create new FIFOs to reduce the sleep time of a processing element that exceeds the predetermined threshold. Sleep time is essentially time when a processing element is not producing meaningful results, so it is generally desirable to minimize the amount of time a processing element spends in a sleep mode. In some embodiments, the server 710 may serve as an allocation manager to process requests for adding or freeing FIFOs, and/or changing the size of existing FIFOs in order to optimize operation of the processing elements.

In some embodiments, the server may receive optimization settings from the external network 750. The optimization settings may include a setting to optimize for speed, optimize for memory usage, or balance between speed and memory usage. Additionally, optimization settings may include constraints on the topology, such as a maximum number of paths that may enter or exit a processing element, maximum data block size, and other settings. Thus, the server 710 can perform a reconfiguration based on user-specified parameters via external network 750.

Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in arrangements such as quads and can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0, then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

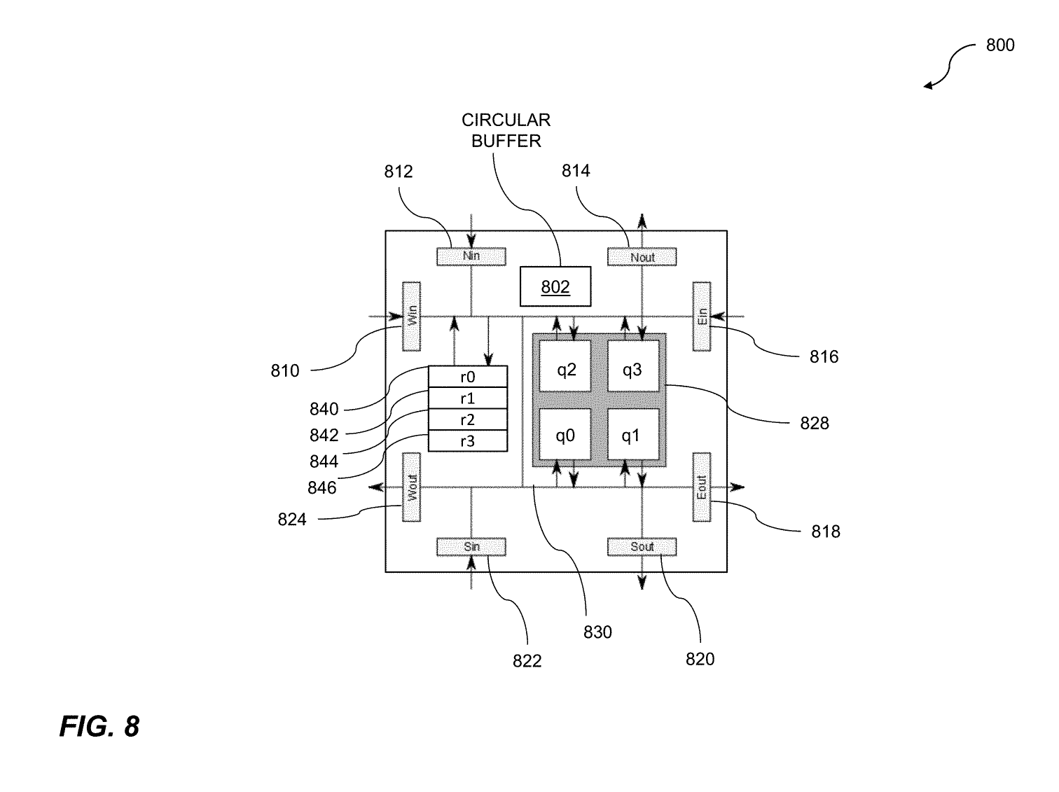

FIG. 8 shows a cluster for coarse-grained reconfigurable processing. The cluster for coarse-grained reconfigurable processing 800 can be used for multithreaded data flow processing within a reconfigurable fabric. The multithreaded data flow can include segmenting code into a plurality of data manipulation operations and allocating segments from the segmenting to sets of processing elements. Data to be processed can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The cluster 800 comprises a circular buffer 802. The circular buffer 802 can be referred to as a main circular buffer or a switch-instruction circular buffer. In some embodiments, the cluster 800 comprises additional circular buffers corresponding to processing elements within the cluster. The additional circular buffers can be referred to as processor instruction circular buffers. The example cluster 800 comprises a plurality of logical elements, configurable connections between the logical elements, and a circular buffer 802 controlling the configurable connections. The logical elements can further comprise one or more of switching elements, processing elements, or storage elements. The example cluster 800 also comprises four processing elements—q0, q1, q2, and q3. The four processing elements can be collectively referred to as a “quad,” and can be jointly indicated by a grey reference box 828. In embodiments, there is intercommunication among and between each of the four processing elements. In embodiments, the circular buffer 802 controls the passing of data to the quad of processing elements 828 through switching elements. In embodiments, the four processing elements 828 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 800 can further comprise storage elements coupled to the configurable connections. As shown, the cluster 800 comprises four storage elements—r0 840, r1 842, r2 844, and r3 846. The cluster 800 further comprises a north input (Nin) 812, a north output (Nout) 814, an east input (Ein) 816, an east output (Eout) 818, a south input (Sin) 822, a south output (Sout) 820, a west input (Win) 810, and a west output (Wout) 824. The circular buffer 802 can contain switch instructions that implement configurable connections. For example, an instruction effectively connects the west input 810 with the north output 814 and the east output 818 and this routing is accomplished via bus 830. The cluster 800 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 802. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 824 to an instruction placing data on the south output 820, such that the data can be output on both output ports within the same pipeline cycle. In a case where data needs to travel to a cluster that is both south and west of the cluster 800, it can be more efficient to send the data directly to the south output port rather than to store the data in a register first, and then to send the data to the west output on a subsequent pipeline cycle.

An L2 switch interacts with the instruction set. A switch instruction typically has a source and a destination. Data is accepted from the source and sent to the destination. There are several sources (e.g. any of the quads within a cluster, any of the L2 directions (North, East, South, West), a switch register, one of the quad RAMs (data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can implement any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8 KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing access to them to be shared by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

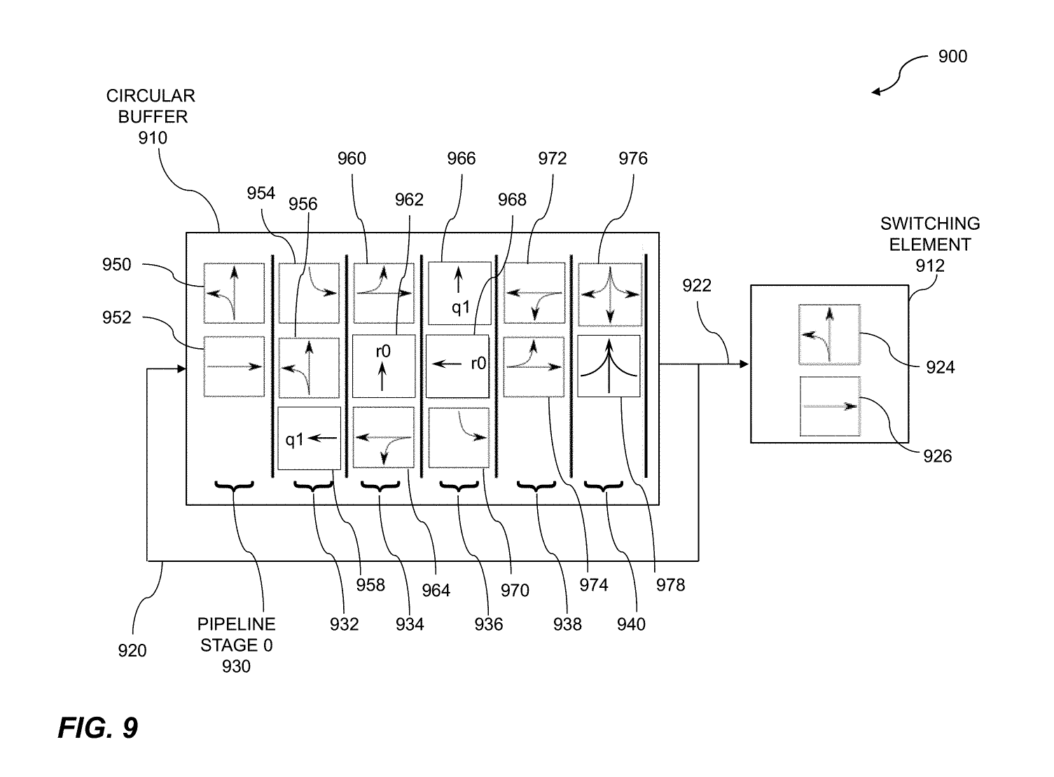

FIG. 9 illustrates a block diagram 900 of a circular buffer. The circular buffer of block diagram 900 can include a switching element 912 corresponding to the circular buffer 910. The circular buffer and the corresponding switching element can be used in part for pipelined tensor manipulation within a reconfigurable fabric. Data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The block diagram 900 describes a processor-implemented method for data manipulation. The circular buffer 910 contains a plurality of pipeline stages. Each pipeline stage contains one or more instructions, up to a maximum instruction depth. In the embodiment shown in FIG. 9, the circular buffer 910 is a 6×3 circular buffer, meaning that it implements a six-stage pipeline with an instruction depth of up to three instructions per stage (column). Hence, the circular buffer 910 can include one, two, or three switch instruction entries per column. In some embodiments, the plurality of switch instructions per cycle can comprise two or three switch instructions per cycle. However, in certain embodiments, the circular buffer 910 supports only a single switch instruction in a given cycle. In the example block diagram 900 shown, pipeline stage 0 930 has an instruction depth of two instructions 950 and 952. Though the remaining pipeline stages 1-5 are not textually labeled in the example block diagram 900, the stages are indicated by callouts 932, 934, 936, 938, and 940. Pipeline stage 1 932 has an instruction depth of three instructions 954, 956, and 958. Pipeline stage 2 934 has an instruction depth of three instructions 960, 962, and 964. Pipeline stage 3 936 also has an instruction depth of three instructions 966, 968, and 970. Pipeline stage 4 938 has an instruction depth of two instructions 972 and 974. Pipeline stage 5 940 has an instruction depth of two instructions 976 and 978. In embodiments, the circular buffer 910 includes 64 columns. During operation, the circular buffer 910 rotates through configuration instructions. The circular buffer 910 can dynamically change operation of the logical elements based on the rotation of the circular buffer. The circular buffer 910 can comprise a plurality of switch instructions per cycle for the configurable connections.

The instruction 952 is an example of a switch instruction. In embodiments, each cluster has four inputs and four outputs, each designated within the cluster's nomenclature as “north,” “east,” “south,” and “west” respectively. For example, the instruction 952 in the diagram 900 is a west-to-east transfer instruction. The instruction 952 directs the cluster to take data on its west input and send out the data on its east output. In another example of data routing, the instruction 950 is a fan-out instruction. The instruction 950 instructs the cluster to take data from its south input and send out the data through both its north output and its west output. The arrows within each instruction box indicate the source and destination of the data. The instruction 978 is an example of a fan-in instruction. The instruction 978 takes data from the west, south, and east inputs and sends out the data on the north output. Therefore, the configurable connections can be considered to be time multiplexed.

In embodiments, the clusters implement multiple storage elements in the form of registers. In the diagram 900 shown, the instruction 962 is a local storage instruction. The instruction 962 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA transfer can be brought out of sleep after the DMA terminates and determines that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 958 is a processing instruction. The instruction 958 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example diagram 900 shown, the circular buffer 910 rotates instructions in each pipeline stage into switching element 912 via a forward data path 922, and also back to a pipeline stage 0 930 via a feedback data path 920. Instructions can include switching instructions, storage instructions, and processing instructions, among others. The feedback data path 920 can allow instructions within the switching element 912 to be transferred back to the circular buffer. Hence, the instructions 924 and 926 in the switching element 912 can also be transferred back to pipeline stage 0 as the instructions 950 and 952. In addition to the instructions depicted on FIG. 9, a no-op instruction can also be inserted into a pipeline stage. In embodiments, a no-op instruction causes execution to not be performed for a given cycle. In effect, the introduction of a no-op instruction can cause a column within the circular buffer 910 to be skipped in a cycle. By contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 958, assuming that the processor q1 was previously in a sleep state. In embodiments, when the instruction 958 takes valid data from the east input and applies that data to the processor q1, the processor q1 wakes up and operates on the received data. In the event that the data is not valid, the processor q1 can remain in a sleep state. At a later time, data can be retrieved from the q1 processor, e.g. by using an instruction such as the instruction 966. In the case of the instruction 966, data from the processor q1 is moved to the north output. In some embodiments, if Xs have been placed into the processor q1, such as during the instruction 958, then Xs would be retrieved from the processor q1 during the execution of the instruction 966 and applied to the north output of the instruction 966.

A collision occurs if multiple instructions route data to a particular port in a given pipeline stage. For example, if instructions 952 and 954 are in the same pipeline stage, they will both send data to the east output at the same time, thus causing a collision since neither instruction is part of a time-multiplexed fan-in instruction (such as the instruction 978). To avoid potential collisions, certain embodiments use preprocessing, such as by a compiler, to arrange the instructions in such a way that there are no collisions when the instructions are loaded into the circular buffer. Thus, the circular buffer 910 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 962), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that monitors the number of records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will ensure that the memory bit is reset to 0 and will thereby prevent a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

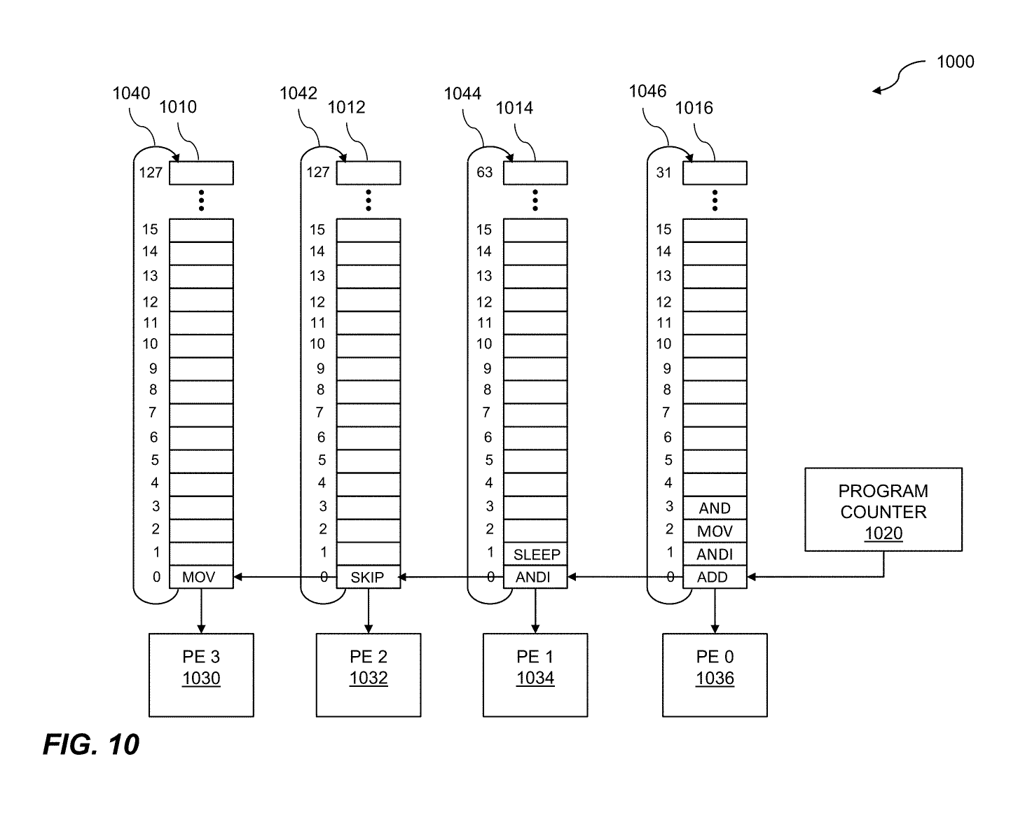

FIG. 10 illustrates a circular buffer and processing elements. A diagram 1000 indicates example instruction execution for processing elements. The processing elements can include a portion of or all of the elements within a reconfigurable fabric. The instruction execution can include instructions for multithreaded data flow processing within a reconfigurable fabric. A circular buffer 1010 feeds a processing element 1030. A second circular buffer 1012 feeds another processing element 1032. A third circular buffer 1014 feeds another processing element 1034. A fourth circular buffer 1016 feeds another processing element 1036. These circular buffers are shown with lengths of 128, 64, and 32 entries, but various lengths are possible. The four processing elements 1030, 1032, 1034, and 1036 can represent a quad of processing elements. In embodiments, the processing elements 1030, 1032, 1034, and 1036 are controlled by instructions received from the circular buffers 1010, 1012, 1014, and 1016. The circular buffers can be implemented using feedback paths 1040, 1042, 1044, and 1046, respectively. In embodiments, the circular buffer can control the passing of data to a quad of processing elements through switching elements, where each of the quad of processing elements is controlled by four other circular buffers (as shown in the circular buffers 1010, 1012, 1014, and 1016) and where data is passed back through the switching elements from the quad of processing elements where the switching elements are again controlled by the main circular buffer. In embodiments, a program counter 1020 is configured to point to the current instruction within a circular buffer. In embodiments with a configured program counter, the contents of the circular buffer are not shifted or copied to new locations on each instruction cycle. Rather, the program counter 1020 is incremented in each cycle to point to a new location in the circular buffer. The circular buffers 1010, 1012, 1014, and 1016 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 1010 and 1012 have a length of 128 instructions, the circular buffer 1014 has a length of 64 instructions, and the circular buffer 1016 has a length of 32 instructions, but other circular buffer lengths are also possible. In some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 10, different circular buffers can have different instruction sets within them. For example, the first circular buffer 1010 contains a MOV instruction. The second circular buffer 1012 contains a SKIP instruction. The third circular buffer 1014 contains a SLEEP instruction and an ANDI instruction. The fourth circular buffer 1016 contains an AND instruction, a MOVE instruction, an ANDI instruction, and an ADD instruction. The operations performed by the processing elements 1030, 1032, 1034, and 1036 are dynamic and can change over time, based on the instructions loaded into the respective circular buffers. As the circular buffers rotate, new instructions can be executed by the respective processing element.

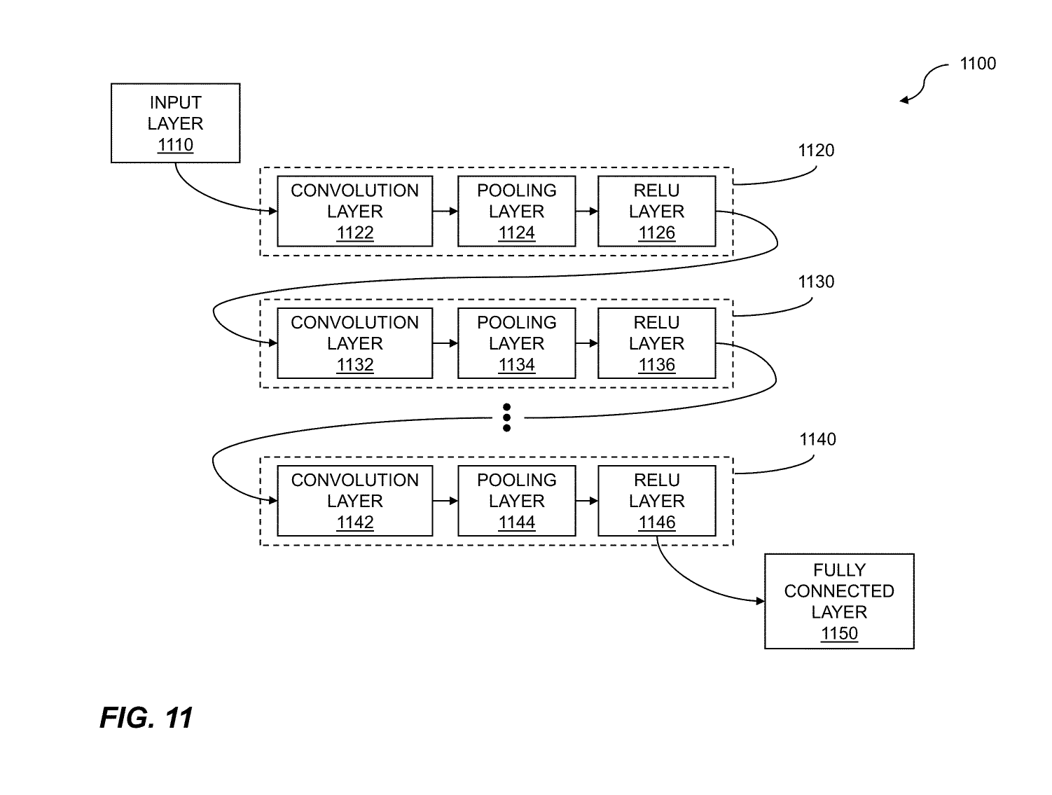

FIG. 11 shows a deep learning block diagram. The deep learning block diagram 1100 can include a neural network such as a deep neural network (DNN), a convolutional neural network, and so on. A convolutional neural network can be based on layers, where the layers can include input layers, output layers, fully connected layers, convolution layers, pooling layers, rectified linear unit (ReLU) layers, and so on. The layers of the convolutional network can be implemented using a reconfigurable fabric. The reconfigurable fabric can include processing elements, switching elements, storage elements, etc. The reconfigurable fabric can be used to perform data manipulation operations based on segments of code. A segment of code can include an agent. Deep learning can be applied to multithreaded data flow processing within a reconfigurable fabric.

A deep learning block diagram 1100 is shown. The block diagram can include various layers, where the layers can include an input layer, hidden layers, a fully connected layer, and so on. In some embodiments, the deep learning block diagram can include a classification layer. The input layer 1110 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 1100, which can represent a network such as a convolutional neural network, can contain a plurality of hidden layers. While three hidden layers, hidden layer 1120, hidden layer 1130, and hidden layer 1140 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 1120 can include convolution layer 1122, pooling layer 1124, and ReLU layer 1126; layer 1130 can include convolution layer 1132, pooling layer 1134, and ReLU layer 1136; and layer 1140 can include convolution layer 1142, pooling layer 1144, and ReLU layer 1146. The convolution layers 1122, 1132, and 1142 can perform convolution operations; the pooling layers 1124, 1134, and 1144 can perform pooling operations, including max pooling, such as data down-sampling; and the ReLU layers 1126, 1136, and 1146 can perform rectification operations. A convolutional layer can reduce the amount of data feeding into a fully connected layer. The block diagram 1100 can include a fully connected layer 1150. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were preprogrammed into configuration mode can be preprogrammed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include offline operations and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The precompiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so one. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM™, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

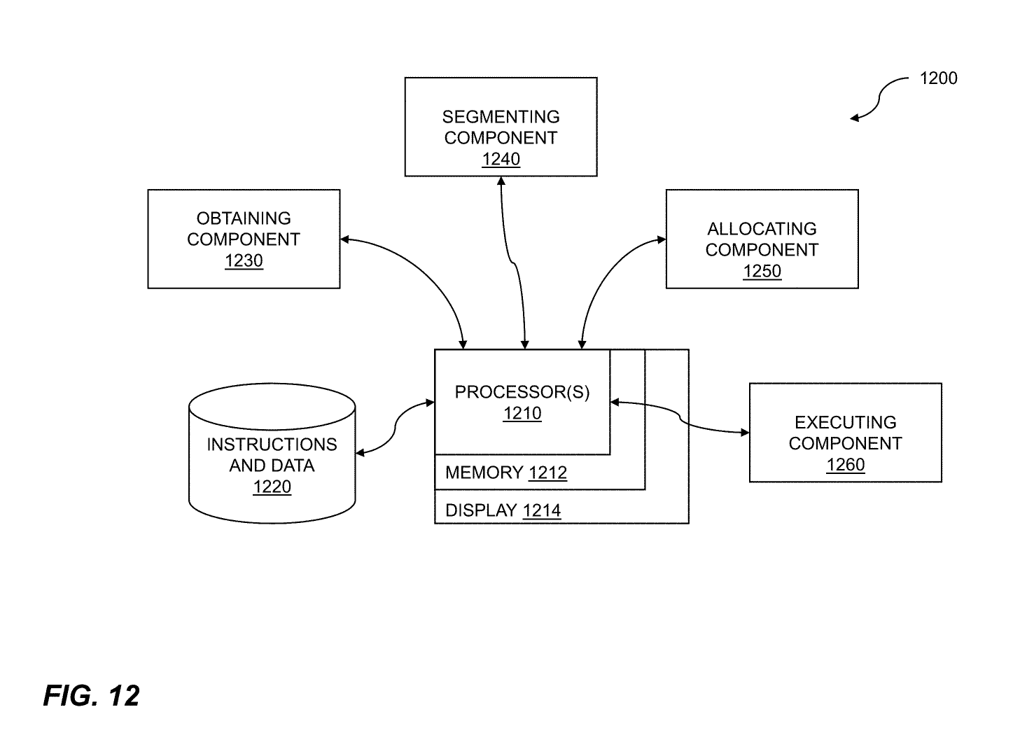

FIG. 12 is system for multithreaded data flow processing within a reconfigurable fabric. The system 1200 can include one or more processors 1210 coupled to a memory 1212 which stores instructions. The system 1200 can include a display 1214 coupled to the one or more processors 1210 for displaying data, intermediate steps, instructions, and so on. In embodiments, one or more processors 1210 are attached to the memory 1212 where the one or more processors, when executing the instructions which are stored, are configured to: obtain code for performing data manipulation on a reconfigurable fabric; segment the code into a plurality of data manipulation operations; allocate a first segment from the segmenting to a first set of processing elements within a plurality of processing elements comprising a reconfigurable fabric; allocate a second segment from the segmenting to a second set of processing elements within the reconfigurable fabric; and execute the first segment on the first set of processing elements while executing the second segment on the second set of processing elements. The system 1200 can include a collection of instructions and data 1220. The instructions and data 1220 may be stored in a database, one or more statically linked libraries, one or more dynamically linked libraries, precompiled headers, source code, flow graphs, kernels, agents, or other suitable formats. The instructions can include instructions for multithreaded data flow processing within a reconfigurable fabric. The data can include unstructured data, tensors, layers and weights, etc. The instructions can include a static schedule for controlling one or more rotating circular buffers.

The system 1200 can include an obtaining component 1230. The obtaining component 1230 can include functions, instructions, or code for performing a data manipulation. The data manipulation can include mathematical operations, Boolean operations, tensor operations, or the like. The data manipulation can be performed within a reconfigurable fabric, where the reconfigurable fabric is comprised of a plurality of elements which can include processing elements, storage elements, and switching elements. The system 1200 can include a segmenting component 1240. The segmenting component 1240 can include functions and instructions for segmenting the code into a plurality of data manipulation operations. The data manipulation operations can include multithreaded operations, where multithreaded operations can include operations that can be performed concurrently. The system 1200 can include an allocating component 1250. The allocating component 1250 can include functions and instructions for allocating a first segment from the segmenting to a first set of processing elements within a plurality of processing elements comprising a reconfigurable fabric. The allocating component can include allocating a second segment from the segmenting to a second set of processing elements within the reconfigurable fabric. The first set of processing elements and the second set of processing elements can include quads, work groups, and so on, within the reconfigurable fabric.

The system 1200 can include an executing component 1260. The executing component can include functions and instructions for executing the first segment on the first set of processing elements while executing the second segment on the second set of processing elements. In embodiments, the first segment comprises a first kernel and the second segment comprises a second kernel. The first kernel and the second kernel can perform operations, where the operations can include calculations or data manipulations. The operations can include mathematical operations, Boolean operations, tensor operations, and so on. The first kernel and the second kernel can be part of data flow processing, where the data flow processing can be represented by a data flow graph. In embodiments, the first kernel and the second kernel can include multithreaded operation. The multithreaded operation can include operations, data manipulations, etc., that can be performed while two or more segments are executed on two or more sets of processing elements. The multithreaded operation can include processing acceleration, processing parallelization, etc. In embodiments, the multithreaded operation can include sharing processing resources. The processing resources that can be shared can include storage. The storage can include storage elements within the reconfigurable fabric, storage separate from the reconfigurable fabric, and so on. The sharing processing resources can include sharing values of kernel variables, kernel states, and the like. Communication can take place between and among kernels while the kernels are being executed. The communication can support synchronization between and among the kernels. In embodiments, the synchronization between the first kernel and the second kernel uses semaphores.

The system 1200 can include a computer program product embodied in a non-transitory computer readable medium for data manipulation, the computer program product comprising code which causes one or more processors to perform operations of: obtaining code for performing data manipulation on a reconfigurable fabric; segmenting the code into a plurality of data manipulation operations; allocating a first segment from the segmenting to a first set of processing elements within a plurality of processing elements comprising a reconfigurable fabric; allocating a second segment from the segmenting to a second set of processing elements within the reconfigurable fabric; and executing the first segment on the first set of processing elements while executing the second segment on the second set of processing elements.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data manipulation comprising:
obtaining code for performing data manipulation on a reconfigurable fabric;
segmenting the code into a plurality of data manipulation operations;
allocating a first segment from the segmenting to a first set of processing elements within a plurality of processing elements comprising a reconfigurable fabric;
allocating a second segment from the segmenting to a second set of processing elements within the reconfigurable fabric; and
executing the first segment on the first set of processing elements while executing the second segment on the second set of processing elements.

2. The method of claim 1 wherein the first segment comprises a first kernel and the second segment comprises a second kernel.

3. The method of claim 2 wherein the first kernel and the second kernel are part of data flow processing.

4. (canceled)

5. The method of claim 2 wherein the first kernel and the second kernel comprise multithreaded operation, wherein the multithreaded operation comprises concurrently executed threads.

6. The method of claim 5 wherein the multithreaded operation comprises processing acceleration.

7. (canceled)

8. The method of claim 5 wherein the multithreaded operation comprises sharing processing resources.

9. (canceled)

10. The method of claim 8 wherein the sharing processing resources comprises sharing values of kernel variables and kernel states.

11. The method of claim 5 wherein the multithreaded operation comprises synchronization between the first kernel and the second kernel.

12. The method of claim 11 wherein the synchronization between the first kernel and the second kernel uses semaphores.

13. (canceled)

14. The method of claim 1 wherein accesses of memory by the first segment and accesses of memory by the second segment occur without contention.

15. The method of claim 1 wherein the first set of processing elements accesses a first memory while executing the first segment.

16. The method of claim 15 wherein the first memory comprises storage elements within the reconfigurable fabric.

17. The method of claim 15 wherein the first memory comprises memory external to the reconfigurable fabric.

18. The method of claim 17 wherein the first memory external to the reconfigurable fabric comprises direct memory access storage.

19. The method of claim 15 wherein the second set of processing elements accesses a second memory while executing the second segment.

20. The method of claim 19 wherein the first memory and the second memory are unique from one another.

21. The method of claim 19 wherein the first memory and the second memory are within one or more hybrid memory cubes.

22. The method of claim 1 wherein the executing the first segment and the executing the second segment are part of machine learning.

23-30. (canceled)

31. The method of claim 1 further comprising dynamically allocating a third segment from the segmenting to the second set of processing elements within the reconfigurable fabric.

32. The method of claim 1 further comprising dynamically allocating a third segment from a segmenting of code for performing a further data manipulation to the second set of processing elements within the reconfigurable fabric.

33. The method of claim 1 wherein the allocating occurs during runtime.

34. A computer program product embodied in a non-transitory computer readable medium for data manipulation, the computer program product comprising code which causes one or more processors to perform operations of:
obtaining code for performing data manipulation on a reconfigurable fabric;
segmenting the code into a plurality of data manipulation operations;
allocating a first segment from the segmenting to a first set of processing elements within a plurality of processing elements comprising a reconfigurable fabric;
allocating a second segment from the segmenting to a second set of processing elements within the reconfigurable fabric; and
executing the first segment on the first set of processing elements while executing the second segment on the second set of processing elements.

35. A computer system for data manipulation comprising:
a memory which stores instructions;
one or more processors attached to the memory wherein the one or more processors, when executing the instructions which are stored, are configured to:
obtain code for performing data manipulation;
segment the code into a plurality of data manipulation operations;
allocate a first segment from the segmenting to a first set of processing elements within a plurality of processing elements comprising a reconfigurable fabric;
allocate a second segment from the segmenting to a second set of processing elements within the reconfigurable fabric; and
execute the first segment on the first set of processing elements while executing the second segment on the second set of processing elements.
